(19) United States
(12) Patent Application Publication
(10) Pub. No.: US 2012/0314139 A1
(43) Pub. Date: Dec. 13, 2012

(54) PASS THROUGH DIGITAL TELEVISION SIGNAL THROUGH NON-TV CONSUMER ELECTRONICS (CE) DEVICE

(75) Inventor: Brian M. Siegel, Carlsbad, CA (US)

(73) Assignee: SONY CORPORATION

(21) Appl. No.: 13/154,900

(22) Filed: Jun. 7, 2011

(51) Int. Cl. H04N 5/50

(52) U.S. Cl. 348/731; 348/E05.097

(57) ABSTRACT

A digital TV tuner is included in an audio or video device that typically does not have a TV tuner or is expected to have a TV tuner. Such provisioning affords a user free access to broadcast (e.g., NBC, CBS, ABC, Fox, PBS, etc.) channels that may otherwise be provided by another third party via paid subscription or other service level as part of a package, thus allowing consumers the choice of bypassing their cable or satellite or other video content service provider by providing access to readily available broadcast video content services. Devices in which the digital TV tuner include but are not limited to Blu-ray players; streaming media players; audio receivers; soundbars; multi-room audio speakers or source devices; cameras; camcorders; personal audio players; and portable DVD or Blu-ray players.

### FIELD OF THE INVENTION

The present application relates generally to passing through digital TV signals through non-TV CE devices.

### BACKGROUND OF THE INVENTION

Consumers of video-enabled devices such as modern digital TVs typically are required to pay for a suite of video content services that includes local broadcast channels that are otherwise mandated as available for free. Examples include major television network stations.

### SUMMARY OF THE INVENTION

Uniqueness is accorded to a non-TV consumer electronic (CE) device such as a home theater speaker system known as a “Soundbar”, or an audio receiver, or disk player such as a Btu-ray player, or a CE device docking station, etc. by providing a TV tuner in the device for access to over the air broadcasts for free. Additional uniqueness comes in to play when combined with a network identifier that allows a user to send/receive this content on other video enabled devices in the home.

A consumer electronic (CE) device includes a TV tuner in a housing and an output port to send out a signal received by the TV tuner. A processor is included in the housing and accesses/executes instructions stored on a computer readable medium also in the housing. The CE device receives free broadcast signals through the TV tuner and provides the signals through the output port to an apparatus that has a video display for presentation of the signals on the apparatus having a video display. The housing of the CE device further holds one or more of the following: a Blu-ray disk player, a streaming media player, an audio receiver, a home theater system soundbar, multi-room audio speakers, a camera, a camcorder, a personal audio player, and/or a portable video disk player.

The CE device may include a coaxial cable or high definition multimedia interface (HDMI) cable interconnecting the CE device to the apparatus having a video display. The output port can be established at least in part by a wireless transceiver. The signals from the TV tuner may be sent to the apparatus having a video display through the wireless transceiver.

In another aspect, the method in which a CE device of a type ordinarily not having a TV tuner but nevertheless provided with a TV tuner to receive, for free, over-the-air (OTA) broadcast TV signals receives the free, OTA broadcast TV signals at the CE device. The CE device sends the free, OTA broadcast TV signals from the CE device to a video display apparatus to enable the video display apparatus to display TV programming represented by the free, over-the-air (OTA) broadcast TV signals without requiring a subscription with a TV signal provider.

In another aspect, an apparatus has a digital TV tuner in an audio or video device that typically does not have a TV tuner or is expected to have a TV tuner to afford a user free access to broadcast channels that otherwise are provided by another third party via paid subscription or other service level as part of a package, thus allowing consumers a choice of bypassing cable or satellite or other video content service provider by providing access to readily available broadcast video content services.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of an example CE device with TV tuner embodied as a camera;

FIG. 3 is a block diagram of an example CE device with TV tuner embodied as a Blu-ray disc player; and

FIG. 4 is a block diagram of an example CE device with TV tuner embodied as a personal audio player.

### DETAILED DESCRIPTION OF THE PREFERRED EMBODIMENT

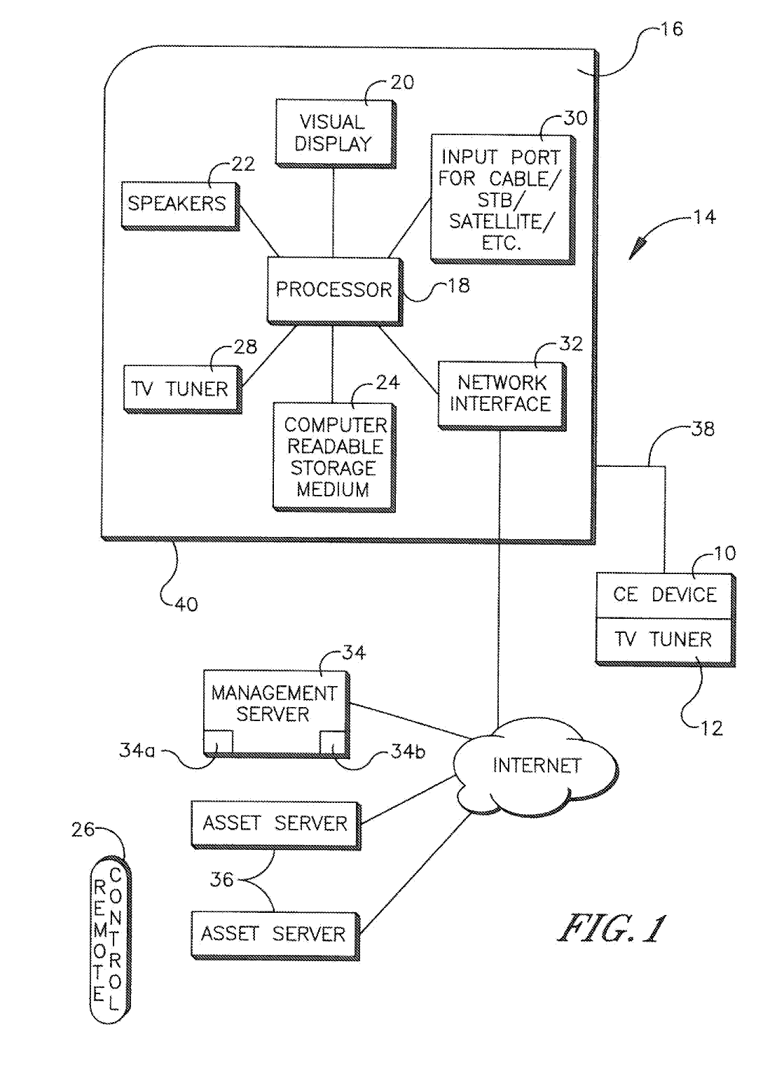

A digital TV tuner may be included inside some or all consumer electronics (CE) devices, in which the tuner allows for access to broadcast content services (e.g. NBC, CBS, ABC, Fox, PBS). Such a CE device is shown in FIG. 1 at reference numeral 10 and includes a TV tuner 12. Consumers can connect their tuner-enabled CE devices such as the device 10 to their television or other video playback device or video playback pass through device such as the TV 14 shown in FIG. 1, and receive and play digital video signals without the use of a standalone digital converter or traditional MSO/Satellite/other provider set-top box type device inputting signals to the TV 14. A preferred method is a direct connection to any CE device. An alternative method is a digital video tuner switch that provides wired or wireless distribution of such content to other devices that may or may not have ability to directly connect to a digital video tuner. An example is a computing or mobile phone device that accesses the digital video tuner wirelessly for playback on the device.

Accordingly, the TV 14 includes a housing 16 bearing a digital processor 18. The processor 18 can control a visual display 20 and an audible display 22 such as one or more speakers. The visual display 20 may be a touch screen display or high definition TV display or other appropriate video display.

The processor 18 may access one or more computer readable storage media 24 such as but not limited to RAM-based storage (e.g., a chip implementing dynamic random access memory (DRAM)) and/or flash memory and/or disk-based storage.

If desired, in addition to the touch screen the processor 18 can receive user input signals from various input devices, including a keypad, a remote control device 26, a point and click device such as a mouse, etc. A TV tuner 28 may be provided in some implementations particularly when the CE device is embodied by a TV to receive TV signals from a source such as a set-top box, satellite receiver, cable head end, etc. However, it will be appreciated that in modern home systems terrestrial broadcast antennas are typically not provided so that the tuner 28 must receive signals via an input 30 that is connected to a source requiring a paid subscription, such as a set top box, a TV cable, or a satellite receiver. Present principles enable the TV 14 to present free broadcast TV signals received by the CE device 10 without having to pay for a subscription.

As shown in FIG. 1, a network interface 32 such as a wired or wireless modem or wireless telephony transceiver may also communicate with the processor 18 to provide connectivity to one or more Internet servers, including a management server 34 with respective processors 34a and respective computer readable storage media 34b. The management server 34 may provide the AV device 14 with selective access to AV content from one or more asset servers 36.

As shown in FIG. 1, the CE device 10 may communicate with the TV 14 through a link 38 such as a wired link, including a HDMI link or coaxial cable, or a wireless link. The signal from the CE device 10 may be combined with a network identifier, e.g., the identifier of the user's home network, to allow the user to send/receive this content to other video enabled devices in the home network and only other video devices in the home network.

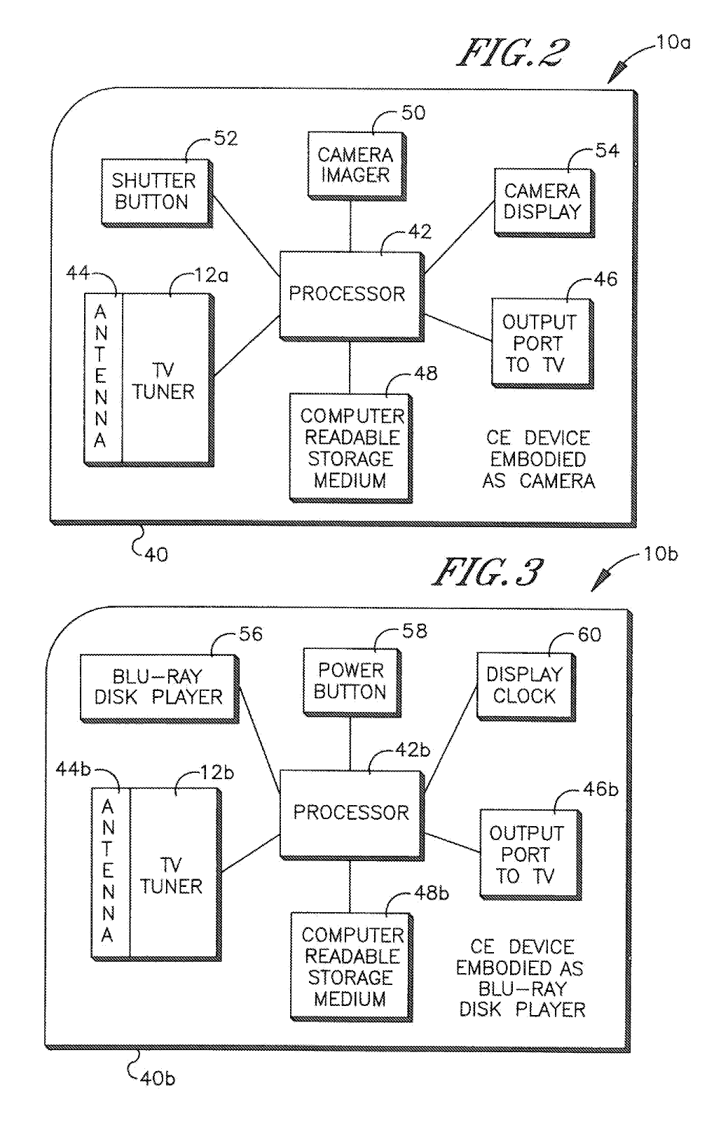

FIG. 2 shows an implementation 10a of the CE device 10 of FIG. 1 in which the CE device 10a is implemented as a camera, principles of FIG. 2 applying equally to camcorders. A TV tuner 12a can be provided in a housing 40 of the CE device 10a along with a processor 42 and an antenna 44 that also can be provided in the housing 40. The processor 42 receives over-the-air (OTA) broadcast signals from the antenna 44 through the TV tuner 12a and sends them through an output port 46 to the display device such as the TV 14 illustrated in FIG. 1.

The instructions for the processor 42 to receive OTA broadcast signals from the antenna 44 through the TV tuner 12a and to send them to the TV 14 through the output port 46 can be stored on a computer readable storage medium 48 housed within the CE device 10a, embodied in this implementation as a camera. A direct link is present between the processor 42 and storage medium 48 in order for instructions to be sent to the processor 42.

The housing 40 can also contain aspects commonly found in most cameras, such as, but not limited to, a camera imager 50, shutter button 52, and a camera display 54, all of which communicate directly with the processor 42. Instructions for the processor 42 to communicate with these aspects can be stored on the storage medium 48. If desired, additional buttons may be included within the housing, such as a power button, a settings button, an image quality button, etc.

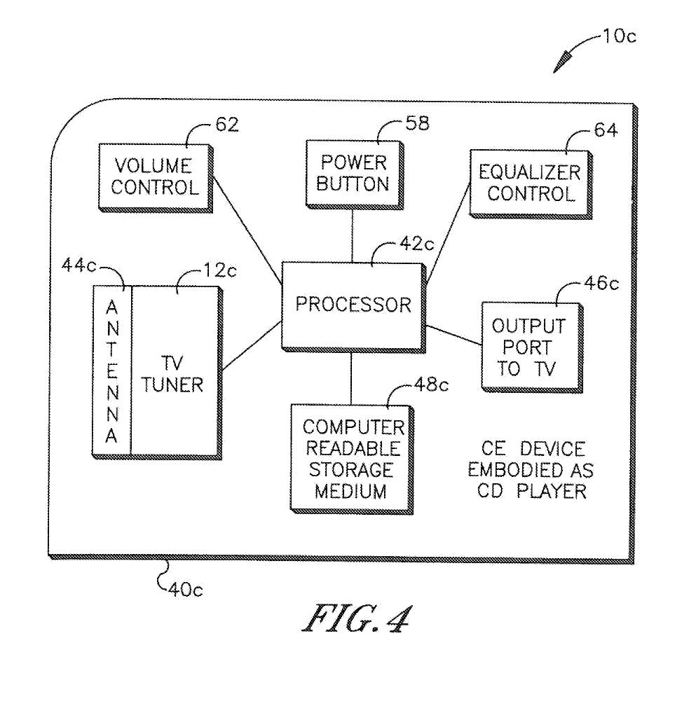

Moving in reference to FIG. 3, an implementation of the CE device, designated 10b, is shown as a Blu-ray disc player, it being understood that other media players may be configured according to the principles shown in FIG. 3. A TV tuner 12b, processor 42h, and antenna 44b can all be held within the housing 40b. The processor 42b receives over-the-air (OTA) broadcast signals from the antenna 44b through the TV tuner 12b and sends them through an output port 46b to the display device such as the TV 14 illustrated in FIG. 1.

The instructions for the processor 42b to receive OTA broadcast signals from the antenna 44b through the TV tuner 12b and to send them to the TV 14 through the output port 46b can be stored on a computer readable storage medium 48b housed within the CE device 10b, embodied in this implementation as a Blu-ray disc player. A link is present between the processor 42b and storage medium 48b in order for instructions to be sent to the processor 42b.

In order for the Blu-ray disc player 10b to perform its primary function of reading Blu-ray discs, a Blu-ray disc drive 56 can be built the housing 40b. The processor 42b communicates with the disc drive 56 based on instructions stored on the storage medium 48b and receives video encoded in Blu-ray format.

The processor 42b also communicates with additional elements commonly housed in Blu-ray disc players, such as, but not limited to, a power button 58 and display clock 60. Instructions for the processor 42b to send and/or receive information to these elements are stored on the storage medium 48b.

Now referring to FIG. 4, an implementation of a CE device 10c is shown as a personal audio player such as a compact disc (CD) player, it being understood that present principles also apply to a home theater system soundbar, multi-room audio speakers, etc. A TV tuner 12c, processor 42c, and antenna 44c can be in a housing 40c. The processor 42c receives over-the-air (OTA) broadcast signals from the antenna 44c through the TV tuner 12c and sends them through an output port 46c to the display device such as the TV 14 illustrated in FIG. 1.

The instructions for the processor 42c to receive OTA broadcast signals from the antenna 44c through the TV tuner 12c and to send them to the TV 14 through the output port 46c can be stored on a computer readable storage medium 48c housed within the CE device 10c, embodied in this implementation as a personal audio player. A link is present between the processor 42c and storage medium 48c in order for instructions to be sent to the processor 42c.

Additional aspects to the CE device, here embodied as a personal audio player, can include, but are not limited to, a volume control 62, the power button 58 as shown in FIG. 4, an equalizer control 64, etc. The volume control 62 enables listeners with a variety of hearing capabilities to adjust the volume level for music being played. Similarly, the equalizer control enables emphasis of aspects of the music being played, such as bass, treble, etc.

While the particular PASS THROUGH DIGITAL TELEVISION SIGNAL THROUGH NON-TV CONSUMER ELECTRONICS (CE) DEVICE is herein shown and described in detail, it is to be understood that the subject matter which is encompassed by the present invention is limited only by the claims.

What is claimed is:

1. Consumer electronic (CE) device comprising:
TV tuner in a housing;
output port; and
processor in the housing and accessing instructions on a computer readable medium in the housing to execute the instructions, the CE device receiving free broadcast signals through the TV tuner and providing the signals through the output port to an apparatus having a video display for presentation of the signals on the apparatus having a video display, wherein the housing of the CE device further holds one or more of:
a Blu-ray disk player, a streaming media player, an audio receiver, a home theater system soundbar, multi-room audio speakers, a camera, a camcorder, a personal audio player, a portable video disk player.

2. The CE device of claim 1, comprising a coaxial cable or high definition multimedia interface (HDMI) cable interconnecting the CE device to the apparatus having a video display.

3. The CE device of claim 1, wherein the output port is established at least in part by a wireless transceiver, the signals from the TV tuner being sent to the apparatus having a video display through the wireless transceiver.

4. The CE device of claim 1, wherein the housing holds a Blu-ray disk player.

5. The CE device of claim 1, wherein the housing holds a streaming media player.

6. The CE device of claim 1, wherein the housing holds an audio receiver.

7. The CE device of claim 1, wherein the housing holds a home theater system soundbar.

8. The CE device of claim 1, wherein the housing holds multi-room audio speakers.

9. The CE device of claim 1, wherein the housing holds a camera.

10. The CE device of claim 1, wherein the housing holds a camcorder.

11. The CE device of claim 1, wherein the housing holds a personal audio player.

12. The CE device of claim 1, wherein the housing holds a portable video disk player.

13. Method, in a CE device of a type ordinarily not having a TV tuner but nevertheless provided with a TV tuner to receive, for free, over-the-air (OTA) broadcast TV signals, the method comprising:
receiving the free, over-the-air (OTA) broadcast TV signals at the CE device; and
sending the free, over-the-air (OTA) broadcast TV signals from the CE device to a video display apparatus to enable the video display apparatus to display TV programming represented by the free, over-the-air (OTA) broadcast TV signals without requiring a subscription with a TV signal provider.

14. The method of claim 13, wherein the CE device is a media player.

15. The method of claim 13, wherein the CE device is an audio receiver or speaker.

16. The method of claim 13, wherein the CE device is a camera.

17. The method of claim 13, wherein the CE device is a camcorder.

18. The method of claim 13, wherein the CE device is a personal audio player.

19. The method of claim 13, wherein the CE device is a portable video disk player.

20. Apparatus comprising:
a digital TV tuner in an audio or video device that typically does not have a TV tuner or is expected to have a TV tuner to afford, a user free access to broadcast channels that otherwise are provided by another third party via paid subscription or other service level as part of a package, thus allowing consumers a choice of bypassing cable or satellite or other video content service provider by providing access to readily available broadcast video content services.
